(19) United States
(12) Patent Application Publication
(10) Pub. No.: US 2008/0122366 A1
(43) Pub. Date: May 29, 2008

(54) Backup architecture for backlight module

(75) Inventors: Ying-Chang Cheng, Taipei Hsien (TW); Chin-Biau Chung, Taipei Hsien (TW)

Correspondence Address: BIRCH STEWART KOLASCH & BIRCH, PO BOX 747, FALLS CHURCH, VA, 22040-0747, US

(73) Assignee: Zippy Technology Corp.

(21) Appl. No.: 11/592,217

(22) Filed: Nov. 3, 2006

(51) Int. Cl. H05B 37/04

(52) U.S. Cl. 315/88

(57) ABSTRACT

A backup architecture for a backlight module comprises a first power system and a second power system, each having an enable mode and a disable mode; and a sensor unit, electrically connected to the first and the second power systems. In the enable mode, the first power system or the second power system is enabled to drive the backlight module to emit light. In the disable mode, the first power system or the second power system is disabled and stops driving the backlight module. The first and the second power systems are interconnected in parallel. When one of the first power system and the second power system enters into the enable mode, the other enters into the disable mode. The sensor unit acquires the working signals of the first and the second power systems and monitors whether the first power system or the second power system is in an abnormal state.

### FIELD OF THE INVENTION

The present invention relates to a backup architecture, particularly to a backup architecture for a backlight module, which utilizes a sensor unit to control power systems or light-emitting systems to support an abnormal situation and enable the backlight module to continue to emit light.

### BACKGROUND OF THE INVENTION

In the technology of display devices, the backlight module plays an important role. In the current backlight module, the common light-emitting elements include: the electron luminescence element, the cold cathode fluorescent lamp, and the light-emitting diode. Based on the positions of light sources, backlight modules may be categorized into the directly-below type and the side-light type. The vividness of the colors presented by a display device correlates with the uniformity of the brightness generated by light-emitting elements. However, a backlight module is usually driven by a high voltage. If the current for a backlight module is unstable, or if a backlight module maintains a saturated brightness for a long time, the light-emitting elements thereof are apt to malfunction, and the service life of the light-emitting elements will be shortened. Even though only a single one of the tube lamps of a backlight module malfunctions, the backlight module cannot output a uniform and sufficient brightness, and the display device cannot present clear images to users. Thus, the user has to replace the damaged lamp or even the entire display device. If the display device is used in a critical situation, such as an airplane, national-defense equipment or the radar of a control tower, the interruption of the operation of the display device may cause an unrecoverable damage. Such a problem is often solved with dual display devices. However, dual display devices not only require more money but also occupy more space. Thus, a backlight module, which not only is free from interrupted operation but also achieves cost-efficiency and space efficiency, is highly desired.

### SUMMARY OF THE INVENTION

The primary objective of the present invention is to provide a backup architecture for a backlight module, wherein the damaged power system is disabled, and another power system is enabled to drive the backlight module; thereby, the backlight module will not be influenced by the damaged power system but can still be driven to emit light by another power system.

To achieve the abovementioned objective, the present invention proposes a backup architecture for a backlight module, which acquires a driving power from a power source and a frequency signal from a control unit to drive a backlight module to emit light and comprises: a first power system and a second power system, each having an enable mode and a disable mode; and a sensor unit, electrically connected to the first power system and the second power system.

In the enable mode, the first power system or the second power system acquires a frequency signal from the control unit and a driving power from the power source and modulates/boosts the acquired driving power to drive the backlight module to emit light. In the disable mode, the first power system or the second power system is disabled and stops driving the backlight module. The first power system and the second power system are interconnected in parallel. When one of the first power system and the second power system enters into the enable mode, the other enters into the disable mode.

The sensor unit acquires the working signals of the first power system and the second power system and monitors whether the first power system or the second power system is in an abnormal state. When the sensor unit finds that the first power system or the second power system is in the abnormal state, it makes the damaged power system enter into the disable mode and makes the other one enter into the enable mode.

Another objective of the present invention is to provide a backup architecture for a backlight module, wherein the damaged light-emitting system is disabled, and another light-emitting system is enabled to emit light; thereby, the backlight module will not be influenced by the damaged light-emitting system but can still be supported by another light-emitting system. The embodiment of this objective is different from that of the former objective: in the embodiment of this objective, when the light-emitting element or the control unit of one light-emitting system malfunctions, another light-emitting system supports the backlight module.

To achieve the abovementioned objective, the present invention proposes another backup architecture for a backlight module, which acquires a driving power from a power source and comprises: a first light-emitting system, having an enable mode and a disable mode; a second light-emitting system, having an enable mode and a disable mode; and a sensor unit, electrically connected to the first light-emitting system and the second light-emitting system.

In the enable mode, the first light-emitting system acquires a driving power from the power source and modulates/boosts the acquired driving power to drive a first light-emitting element to emit light. In the disable mode, the first light-emitting system is disabled and stops driving the first light-emitting element.

In the enable mode, the second light-emitting system acquires a driving power from the power source and modulates/boosts the acquired driving power to drive a second light-emitting element to emit light. In the disable mode, the second light-emitting system is disabled and stops driving the second light-emitting element. The first light-emitting system and the second light-emitting system are interconnected in parallel. When one of the first light-emitting system and the second light-emitting system enters into the enable mode, the other enters into the disable mode.

The sensor unit acquires the working signals of the first light-emitting system and the second light-emitting system and monitors whether the first light-emitting system or the second light-emitting system is in an abnormal state. When the sensor unit finds that the first light-emitting system or the second light-emitting system is in the abnormal state, it makes the damaged light-emitting system enter into the disable mode and makes the other one enter into the enable mode.

### BRIEF DESCRIPTION OF THE DRAWINGS

FIG. 1 is a block diagram schematically showing the architecture according to a first embodiment of the present invention.

FIG. 2 is a block diagram schematically showing the architecture according to a second embodiment of the present invention.

### DETAILED DESCRIPTION OF THE PREFERRED EMBODIMENTS

The technical contents of the present invention will be described in detail in cooperation with the drawings below.

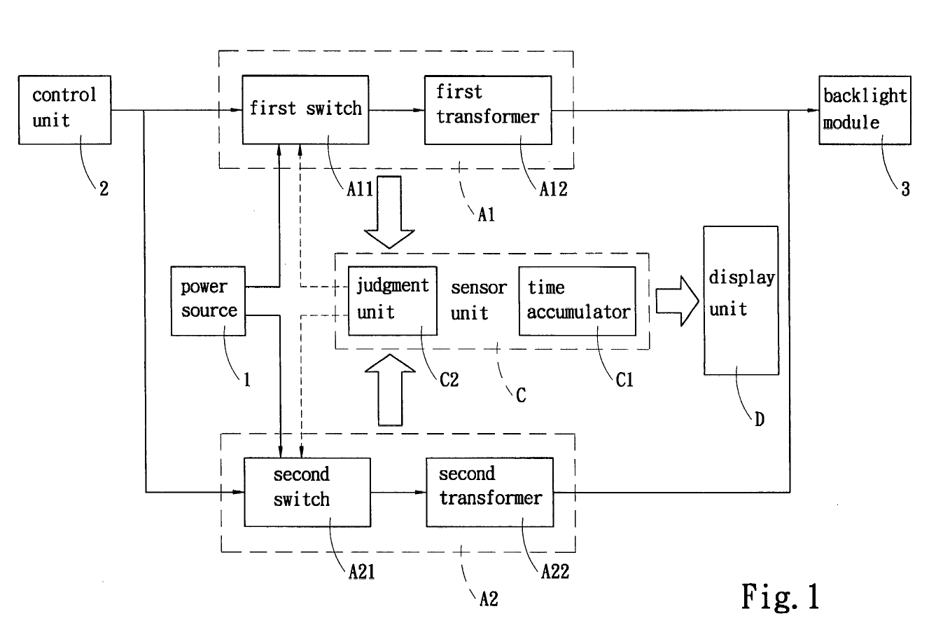

Refer to FIG. 1 a block diagram schematically showing the architecture according to a first embodiment of the present invention.

As shown in FIG. 1, the backup architecture for a backlight module of the present invention acquires a driving power from a power source 1 and a frequency signal from a control unit 2 to drive a backlight module 3 to emit light and comprises: a first power system A1 and a second power system A2, each having an enable mode and a disable mode; and a sensor unit C, electrically connected to the first power system A1 and the second power system A2.

In the enable mode, the first power system A1 or the second power system A2 acquires a frequency signal from the control unit 2 and a driving power from the power source 1 and modulates/boosts the acquired driving power to drive the backlight module 3 to emit light. In the disable mode, the first power system A1 or the second power system A2 is disabled and stops driving the backlight module 3. The first power system A1 and the second power system A2 are interconnected in parallel. When one of the first power system A1 and the second power system A2 enters into the enable mode, the other enters into the disable mode.

The sensor unit C acquires the working signals of the first power system A1 and the second power system A2 and monitors whether the first power system A1 or the second power system A2 is in an abnormal state. When the sensor unit C finds that the first power system A1 or the second power system A2 is in the abnormal state, it makes the damaged power system enter into the disable mode and makes the other one enter into the enable mode.

In this embodiment, the first power system A1 has a first transformer A12 used to boost the driving power to drive the backlight module 3 and a first switch A11 arranged between the first transformer A12 and the control unit 2 and used to shunt the driving power. The frequency signal of the control unit 2 is output to the first switch A11 to determine the turn-on time of the first switch A11. When the sensor unit C detects the abnormality of the first switch A11 or the first transformer A12 of the first power system A1, the sensor unit C sends a first disable signal to turn off the first switch A11 and make the first power system A1 enter into the disable mode. The second power system A2 has a second transformer A22 used to boost the driving power to drive the backlight module 3 and a second switch A21 arranged between the second transformer A22 and the control unit 2 and used to shunt the driving power. The frequency signal of the control unit 2 is output to the second switch A21 to determine the turn-on time of the second switch A21. When the sensor unit C detects the abnormality of the second switch A21 or the second transformer A22 of the second power system A2, the sensor unit C sends a second disable signal to turn off the second switch A21 and make the second power system A2 enter into the disable mode.

When the first power system A1 or the second power system A2 is in the abnormal state, the damaged power system is switched from the enable mode to the disable mode and stops driving the backlight module 3, and the other one is started to enter into the enable mode to drive the backlight module 3 to emit light. Thereby, the backlight module 3 will not be influenced by the damaged power system but can still be driven to emit light by the other power system.

Naturally, more power systems (such third, fourth, fifth and sixth power systems) may also be used in the present invention to drive the backlight module 3 alternately. In considering the space and cost of the backlight module 3, the embodiment adopting only two power systems is used to exemplify the present invention. However, it is not intended to limit the scope of the present invention. Any equivalent modification or variation according to the spirit of the present invention, which adopts multiple backup power systems to support a backlight module alternately, is to be also included within the scope of the present invention.

The sensor unit C further comprises: a time accumulator C1 and a judgment unit C2. The time accumulator C1 accumulates the working time of the first power system A1 and the second power system A2 from the working signals of the first power system A1 and the second power system A2. When the accumulated working time of the first power system A1 or the second power system A2 exceeds a preset time value, the first power system A1 or the second power system A2 enters into the disable mode, and the other one enters into the enable mode. For example, if the preset time value is 1000 hours, and if the accumulated working time of the first power system A1 exceeds 1000 hours, the time accumulator C1 sends a pseudo-abnormal signal to make the sensor unit C presume that the first power system A1 is in the abnormal state; thus, the first power system A1 enters into the disable mode, and the second power system A2 enters into the enable mode.

Thereby, in this embodiment, the first power system A1 and the second power system A2 work alternately. Thus, the service lives of the first power system A1 and the second power system A2 are prolonged.

The judgment unit C2 is used to determine whether the physical working state of the first power system A1 or the second power system A2 is abnormal. The determination of the judgment unit C2 is not affected by the pseudo-abnormal signal of the time accumulator C1. When the physical working state of one power system is determined to be abnormal, the other power system will be maintained in the enable state no matter whether the accumulated working time of the other one has exceeded the preset time value.

In this embodiment, one power system will replace the other power system having accumulated its working time to the preset time value; if the replacement power system malfunctions, the original power system will resume supporting the backlight module.

Besides, the sensor unit C is electrically connected to a display unit D, and the display unit D presents the physical working states of the first power system A1 and the second power system A2.

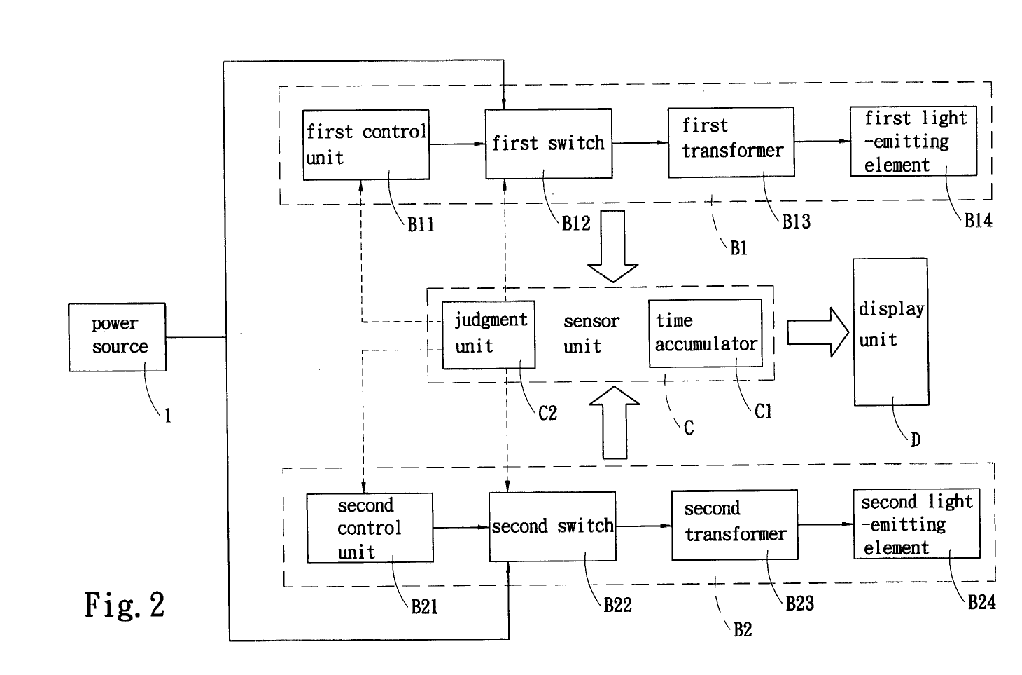

Refer to FIG. 2 a block diagram schematically showing the architecture according to a second embodiment of the present invention.

As shown in FIG. 2, the backup architecture for a backlight module of the present invention acquires a driving power from a power source 1 and comprises: a first light-emitting system B1, having an enable mode and a disable mode; a second light-emitting system B2, having an enable mode and a disable mode; and a sensor unit C, electrically connected to the first light-emitting system B1 and the second light-emitting system B2.

In the enable mode, the first light-emitting system B1 acquires a driving power from the power source 1 and modulates/boosts the driving power to drive a first light-emitting element B14 to emit light. In the disable mode, the first light-emitting system B1 is disabled and stops driving the first light-emitting element B14.

In the enable mode, the second light-emitting system B2 acquires a driving power from the power source 1 and modulates/boosts the driving power to drive a second light-emitting element B24 to emit light. In the disable mode, the second light-emitting system B2 is disabled and stops driving the second light-emitting element B24. The first light-emitting system B1 and the second light-emitting system B2 are interconnected in parallel. When one of the first light-emitting system B1 and the second light-emitting system B2 enters into the enable mode, the other one enters into the disable mode.

The sensor unit C acquires the working signals of the first light-emitting system B1 and the second light-emitting system B2 and monitors whether the first light-emitting system B1 or the second light-emitting system B2 is in an abnormal state. When the sensor unit C finds that the first light-emitting system B1 or the second light-emitting system B2 is in the abnormal state, it makes the damaged light-emitting system enter into the disable mode and makes the other one enter into the enable mode.

In this embodiment, the first light-emitting system B1 has a first control unit B11 outputting a first frequency signal; a first transformer B13 boosting the driving power to drive the first light-emitting element B14; and a first switch B12 arranged between the first control unit B11 and the first transformer B13 and used to shunt the driving power. The first frequency signal is output to the first switch B12 to determine the turn-on time of the first switch B12. When the sensor unit C detects the abnormality of the first light-emitting system B1, it sends a first disable signal to turn off the first switch B12. When the sensor unit C detects the abnormality of the first light-emitting system B1, the sensor unit C may alternatively sends out a first control signal to modify the first frequency signal of the first control unit B11 to make the turn-on time of the first switch B12 be zero or very short and the first light-emitting system B1 enter into the disable mode. The second light-emitting system B2 has a second control unit B21 outputting a second frequency signal; a second transformer B23 boosting the driving power to drive the second light-emitting element B24; and a second switch B22 arranged between the second control unit B21 and the second transformer B23 and used to shunt the driving power. The second frequency signal is output to the second switch B22 to determine the turn-on time of the second switch B22. When the sensor unit C detects the abnormality of the second light-emitting system B2, it sends a second disable signal to turn off the second switch B22. When the sensor unit C detects the abnormality of the second light-emitting system B2, the sensor unit C may alternatively sends out a second control signal to modify the second frequency signal of the second control unit B21 to make the turn-on time of the second switch B22 be zero or very short and the second light-emitting system B2 enter into the disable mode.

When the first light-emitting system B1 or the second light-emitting system B2 is in the abnormal state, the damaged light-emitting system is switched from the enable mode to the disable mode and stops emitting light, and the other one is started to enter into the enable mode and emits light. Thereby, the backlight module 3 will not be influenced by the damaged light-emitting system but can still be supported by the other light-emitting system. The second embodiment is different from the first embodiment: in the second embodiment, when the light-emitting element or the control unit of one light-emitting system malfunctions, the other light-emitting system supports the backlight module.

Naturally, more light-emitting systems (such third, fourth, fifth and sixth light-emitting systems) may also be used in the present invention to emit light alternately. In considering the space and cost of the backlight module 3, the embodiment adopting only two light-emitting systems is used to exemplify the present invention. However, it is not intended to limit the scope of the present invention. Any equivalent modification or variation according to the spirit of the present invention, which adopts multiple backup light-emitting systems to emit light alternately, is to be also included within the scope of the present invention.

The sensor unit C further comprises: a time accumulator C1 and a judgment unit C2. The time accumulator C1 accumulates the working time of the first light-emitting system B1 and the second light-emitting system B2 from the working signals of the first light-emitting system B1 and the second light-emitting system B2. When the accumulated working time of the first light-emitting system B1 or the second light-emitting system B2 exceeds a preset time value, the first light-emitting system B1 or the second light-emitting system B2 enters into the disable mode, and the other one enters into the enable mode. For example, if the preset time value is 1000 hours, and if the accumulated working time of the first light-emitting system B1 exceeds 1000 hours, the time accumulator C1 sends a pseudo-abnormal signal to make the sensor unit C presume that the first light-emitting system B1 is in the abnormal state; thus, the first light-emitting system B1 enters into the disable mode, and the second light-emitting system B2 enters into the enable mode.

Therefore, in this embodiment, the first light-emitting system B1 and the second light-emitting system B2 work alternately. Thus, the service lives of the first light-emitting system B1 and the second light-emitting system B2 are prolonged.

The judgment unit C2 is used to determine whether the physical working state of the first light-emitting system B1 or the second light-emitting system B2 is abnormal. The determination of the judgment unit C2 is not affected by the pseudo-abnormal signal of the time accumulator C1. When the physical working state of one light-emitting system is determined to be abnormal, the other light-emitting system will be maintained in the enable state no matter whether the accumulated working time of the other one has exceeded the preset time value.

In this embodiment, one light-emitting system will replace the other light-emitting system having accumulated its working time to the preset time value; if the replacement light-emitting system malfunctions, the original light-emitting system will resume emitting light to support the backlight module.

Besides, the sensor unit C is electrically connected to a display unit D, and the display unit D presents the physical working states of the first light-emitting system B1 and the second light-emitting system B2. An example of the contents presented on the display unit D is shown in Table. 1.

TABLE 1

| | |
|---|---|
| Light-emitting system | Physical working state |
| First light-emitting system | Normal, light emitting |
| Second light-emitting | Abnormal |
| system | |

Summarily, in the present invention, multiple power systems or multiple light-emitting systems in cooperation with a sensor unit are used to support a backlight module; thereby, once one of the power systems or the light-emitting systems malfunctions, another can still support the backlight module to operate. Further, the pseudo-abnormal signal of the time accumulator C1 can make the power systems or the light-emitting systems work alternately; thereby, the service life can be prolonged; when the replacement power system or the replacement light-emitting system is damaged, the judgment unit C2 can prevent the backlight module from being unable to emit light. Besides, the user can learn the physical working states of the power systems or the light-emitting systems from the display unit D. The present invention indeed possesses novelty and non-obviousness and meets the requirements of an invention patent. Therefore, the inventor files the patent application for the present invention. It will be greatly appreciated that the application should be fast approved.

Those described above are the preferred embodiments to exemplify the present invention. However, it is not intended to limit the scope of the present invention. Any equivalent modification or variation according to the spirit of the present invention is to be also included within the scope of the present invention.

What is claimed is:

1. A backup architecture for a backlight module, which acquires a driving power from a power source and a frequency signal from a control unit to drive a backlight module to emit light, comprising:
a first power system and a second power system, each having an enable mode and a disable mode, wherein in said enable mode, said first power system or said second power system acquires a frequency signal from said control unit and a driving power from said power source and modulates/boosts said driving power to drive said backlight module to emit light; in said disable mode, said first power system or said second power system is disabled and stops driving said backlight module; said first power system and said second power system are interconnected in parallel; when one of said first power system and said second power system enters into said enable mode, the other enters into said disable mode; and
a sensor unit, electrically connected to said first power system and said second power system, wherein said sensor unit acquires the working signals of said first power system and said second power system and monitors whether said first power system or said second power system is in an abnormal state; when said sensor unit finds that said first power system or said second power system is in said abnormal state, said sensor unit makes the damaged power system enter into said disable mode and makes the other one enter into said enable mode.

2. The backup architecture for a backlight module according to claim 1, wherein said first power system has a first transformer used to boost said driving power to drive said backlight module and a first switch arranged between said first transformer and said control unit and used to shunt said driving power; and said frequency signal of said control unit is output to said first switch to determine the turn-on time of said first switch.

3. The backup architecture for a backlight module according to claim 1, wherein said second power system has a second transformer used to boost said driving power to drive said backlight module and a second switch arranged between said second transformer and said control unit and used to shunt said driving power; and said frequency signal of said control unit is output to said second switch to determine the turn-on time of said second switch.

4. The backup architecture for a backlight module according to claim 1, wherein said sensor unit is electrically connected to a display unit, and said display unit presents the physical working states of said first power system and said second power system.

5. The backup architecture for a backlight module according to claim 1, wherein said sensor unit further comprises a time accumulator; said time accumulator accumulates the working time of said first power system and said second power system from said working signals of said first power system and said second power system; when the accumulated working time of said first power system or said second power system exceeds a preset time value, said first power system or said second power system enters into said disable mode, and the other one enters into said enable mode.

6. The backup architecture for a backlight module according to claim 5, wherein said sensor unit further comprises a judgment unit; said judgment unit is used to determine whether the physical working state of said first power system or said second power system is abnormal; when said physical working state of one power system is determined to be abnormal, the other power system will be maintained in said enable state no matter whether the accumulated working time of the other one has exceeded said preset time value.

7. A backup architecture for a backlight module, which acquires a driving power from a power source, comprising:
a first light-emitting system, having an enable mode and a disable mode, wherein in said enable mode, said first light-emitting system acquires a driving power from said power source and modulates/boosts said driving power to drive a first light-emitting element to emit light; in said disable mode, said first light-emitting system is disabled and stops driving said first light-emitting element;
a second light-emitting system, having an enable mode and a disable mode, wherein in said enable mode, said second light-emitting system acquires a driving power from said power source and modulates/boosts said driving power to drive a second light-emitting element to emit light; in said disable mode, said second light-emitting system is disabled and stops driving said second light-emitting element; said first light-emitting system and said second light-emitting system are interconnected in parallel; when one of said first light-emitting system and said second light-emitting system enters into said enable mode, the other one enters into said disable mode; and
a sensor unit, electrically connected to said first light-emitting system and said second light-emitting system, wherein said sensor unit acquires the working signals of said first light-emitting system and said second light-emitting system and monitors whether said first light-emitting system or said second light-emitting system is in an abnormal state; when said sensor unit finds that said first light-emitting system or said second light-emitting system is in said abnormal state, said sensor unit makes the damaged light-emitting system enter into said disable mode and makes the other one enter into said enable mode.

8. The backup architecture for a backlight module according to claim 7, wherein said first light-emitting system has a first control unit outputting a first frequency signal; a first transformer boosting said driving power to drive said first light-emitting element; and a first switch arranged between said control unit and said first transformer and used to shunt said driving power; said first frequency signal is output to said first switch to determine the turn-on time of said first switch.

9. The backup architecture for a backlight module according to claim 7, wherein said second light-emitting system has a second control unit outputting a second frequency signal; a second transformer boosting said driving power to drive said second light-emitting element; and a second switch arranged between said second control unit and said second transformer and used to shunt said driving power; said second frequency signal is output to said second switch to determine the turn-on time of said second switch.

10. The backup architecture for a backlight module according to claim 7, wherein said sensor unit is electrically connected to a display unit, and said display unit presents the physical working states of said first light-emitting system and said second light-emitting system.

11. The backup architecture for a backlight module according to claim 7, wherein said sensor unit further comprises a time accumulator; said time accumulator accumulates the working time of said first light-emitting system and said second light-emitting system from said working signals of said first light-emitting system and said second light-emitting system; when the accumulated working time of said first light-emitting system or said second light-emitting system exceeds a preset time value, said first light-emitting system or said second light-emitting system enters into said disable mode, and the other one enters into said enable mode.

12. The backup architecture for a backlight module according to claim 11, wherein said sensor unit further comprises a judgment unit; said judgment unit is used to determine whether the physical working state of said first light-emitting system or said second light-emitting system is abnormal; when said physical working state of one light-emitting system is determined to be abnormal, the other light-emitting system will be maintained in said enable state no matter whether the accumulated working time of the other one has exceeded said preset time value.
